(19) United States
(12) Patent Application Publication
(10) Pub. No.: US 2004/0014869 A1
(43) Pub. Date: Jan. 22, 2004

(54) Method for preparing silica filled elastomeric compositions

(76) Inventors: Wai Keung Wong, Wezembeek (BE); Hsien-Chang Wang, Bellaire, TX (US); Timothy A. Mills, Rixensart (BE)

Correspondence Address: ExxonMobil Chemical Company, Law Technology, PO Box 2149, Baytown, TX, 77522-2149, US

(21) Appl. No.: 10/297,689

(22) PCT Filed: May 9, 2001
(86) PCT No.: PCT/US01/14975

(51) Int. Cl. C08K 3/34

(52) U.S. Cl. 524/493

(57) ABSTRACT

A process for preparing a cross-linked blend comprising a) mixing a copolymer of a C₄ to C₇ isoolefin and a para-alkylstyrene with silica, b) separately mixing a general purpose rubber with silica, wherein one or more silane coupling agents is mixed with at least one of the silica/copolymer or silica/general purpose rubber blends, and c) mixing the silica/copolymer blend with the silica/general purpose rubber blend. Typical silane coupling agents include bis(3-triethoxysilylpropyl) tetrasulfide, 3-thiocyanatopropyl-triethoxy silane, 3-mercaptopropyl-trimethoxy silane, and one embodiment of the copolymer is a terpolymer of isobutylene, para-methylstyrene, and bromo-para-methylstyrene.

### CROSS REFERENCE TO RELATED APPLICATIONS

This application claims priority to Ser. No. 09/592,757, filed Jun. 13, 2000, and Provisional Application No. 60/211,049, filed Jun. 13, 2000, the disclosures of which are incorporated by reference in their entireties.

### FIELD OF THE INVENTION

The present invention relates to a method for preparing silica filled elastomeric blends and, more particularly, to a method for preparing colorable elastomeric compositions comprising a copolymer of a C₄ to C₇ isoolefin and a para-alkylstyrene, a general purpose rubber, silica and one or more silane coupling agents.

### BACKGROUND OF THE INVENTION

The demand of tire performance from car manufacturers is ever increasing. Today's tires not only need to fulfill the functional requirements of low rolling resistance, high wet traction and wear resistance; criteria such as tire noise and handling as well as cosmetic appeal become increasingly important. While the particular rubber compositions used in each of these applications vary widely in their physical properties, one attribute remains the same—their color. Most rubber compositions are black. Furthermore, most rubber compositions eventually become discolored due to heat, light, ozone, etc. This is particularly true for rubbers used in stressful, demanding applications such as tire sidewalls.

Copolymers of isobutylene and para-methylstyrene that are subsequently brominated (BIMS polymers) can be used for tire sidewalls, among other applications. A commercial embodiment of a BIMS polymer is an EXXPRO™ Elastomer (ExxonMobil Chemical Company, Houston Tex.). One of the main advantages of using a BIMS polymer in tire sidewall is that the tire retains its fine shiny black color when carbon black is used as a filler. Due to the high stability of BIMS polymers, no antioxidant or antiozonant is needed in tire sidewall compound that contains BIMS polymers as one of the elastomer components. Therefore discoloration of normal general purpose rubber (GPR) tire sidewall that is associated with the blooming of these additives does not take place.

Practitioners in this field will point to the presence of the reinforcing filler “carbon black” as a prime reason that most rubbers are black. While this is true, carbon black is not the only factor. In fact, a wide variety of other fillers, curatives, antidegradants, oils and the rubbers themselves can all result in a dark color that is essentially impossible to pigment. This is evident in compositions where carbon black has been replaced with a silica filler and the rubber is still discolored. For example, EP 0 682 071 B1 discloses a silica reinforced tire tread which, due to the presence of the aromatic processing oil, coupling agent, antidegradants and a sulfur curative system, will still be dark in color. In fact, it is uncertain how many of the ingredients present in the rubber composition would have to be changed to produce a colorable composition.

Of course, some colorable elastomeric compositions do exist. White sidewalls on tires are a form of colorable rubber. The white color is achieved by using fillers such as silica, clay, talc and carbonates instead of carbon black and adding titanium dioxide as a whitening pigment. However, the white color comes with a price. The fillers are more fragile than carbon black and result in a weak rubber composition that does not reinforce the tire. Therefore, the rubbers used for white sidewalls are limited in their usefulness.

In addition, WO 99/31178 discloses transparent and colorable elastomeric compositions containing a copolymer of a C₄ to C₇ isoolefin and a para-alkylstyrene, silica and a coupling agent. Other related patents include U.S. Ser. No. 09/691,764, filed on Oct. 18, 2000, assigned to the assignee of the present invention, U.S. Pat. No. 5,817,719, 6,201,054 B1, 6,177,503, and JP 09324069. In particular, U.S. Pat. No. 5,817,719 to Zanzig et al discloses a rubber/para-methylstyrene copolymer mixture containing silica and a silane coupling agent, but does not provide means by which to mix these chemical species to arrive at the desired blend.

However, unlike carbon black, silica interactions poorly with many elastomers and a composition of silica with the elastomer typically does not result in optimal properties in the tire such as a low rolling resistance and high wet traction, as evidenced in the Dynamic properties of the Tan values at −30° C., 0° C., and 60° C. Low rolling resistance is evidenced by low or decreased Tan δ at 50-70° C., while a high wet traction is evidenced by a high or increased Tan δ at 0-10° C. Thus, there remains a problem in the industry of providing a colorable elastomeric composition that retain the advantageous properties of low rolling resistance and high wet traction for use in tires, belts, hoses, and other uses.

### SUMMARY OF THE INVENTION

These and other problems are solved in the present invention, wherein a method is provided of forming an elastomeric composition or “blend” by combining a isoolefin/para-alkylstyrene copolymer and GPR with silica fillers using silane coupling agents. More particularly, in order to obtain the desired viscoelastic properties of silica filled compounds for low rolling resistance (low Tan δ at 50-70° C.) and high wet traction (high Tan δ at 0-10° C.), the use of highly dispersible silica together with an effective silane coupling agent is used.

An embodiment of the present invention is a method of mixing a silane coupling agent (or “silane”) with silica and a isoolefin/para-alkylstyrene copolymer containing composition to obtain polymer compositions that have higher Tan δ at 0-10° C. and also lower Tan δ at 50-70° C. when compared with similar compounds filled with N220 or N660 black. The results obtained indicate that the silane can also act as an effective coupling agent between the isoolefin/para-alkylstyrene copolymer and the silica as can be evidenced from the large increase in the ratio of 300% Modulus to 100% Modulus of the compound. Unlike the case of carbon black filled isoolefin/para-alkylstyrene copolymer, the coupling between isoolefin/para-alkylstyrene copolymer and silica remains intact at high temperature. This enables the silica filled compound to maintain its elasticity and hence low rolling resistance as temperature increases.

### BRIEF DESCRIPTION OF DRAWINGS

FIG. 1 is a representative plot of temperature as a function of time during a typical cycle of silica filled polymer production.

### DETAILED DESCRIPTION OF THE INVENTION

In one embodiment of the present invention, a blend of a general purpose rubber, a para-alkylstyrene-based copolymer, silicon, and a silane coupling agent is produced which is colorable and possesses properties that allow the composition to be used as a reinforcing member in an automobile tire. The term “colorable”, as used herein, is defined as the ability of the base elastomeric composition or “blend” to be pigmented to afford a variety of colored blends. These blends typically do not contain carbon black. The term “blend” is used to refer to the mixture of the copolymer, general purpose rubber, silicon and silane coupling agent, or the mixture of any two or more of these components. A “masterbatch” is a mixture of the copolymer/silicon/silane coupling agent or the general purpose rubber/silicon/silane coupling agent, the blend being a mixture of the masterbatches.

An embodiment of the blend includes a copolymer of an isoolefin and para-alkylstyrene with a general purpose rubber (GPR) such as natural rubber, and silica, that has been reacted in the presence of a silane coupling agent such as a silane-crosslinker. The colorable rubber blends of the present invention contain at least one copolymer of a C₄ to C₇ isoolefin and a para-alkylstyrene, hereinafter “copolymer”. More desirably, the copolymer is a terpolymer of isobutylene, para-methylstyrene and bromo para-methylstyrene (BIMS).

An embodiment of the invention also includes a method of combining the components of the blend, wherein the BIMS copolymer is mixed by any standard means with silica and optionally one or more coupling agents to form a silica/copolymer blend, separately mixing a general purpose rubber with silica and one or more silane coupling agents to form a silica/general purpose rubber blend, and then mixing the silica/copolymer blend with the silica/general purpose rubber blend.

Isoolefin and Para-Alkylstyrene Copolymer Component

The copolymer of a C₄ to C₇ isoolefin and a para-alkylstyrene of the present invention also encompasses terpolymers of a C₄ to C₇ isoolefin, para-alkylstyrene and halogenated para-alkylstyrene. In one embodiment, the elastomeric component is a terpolymer of isobutylene, para-methylstyrene and bromo-para-methylstyrene (BIMS), as disclosed in U.S. Pat. No. 5,162,445. The isoolefin/para-alkylstyrene copolymer typically includes an isoolefin having between 4 and 7 carbon atoms and the copolymer containing from about 0.5% to about 20% by weight para-alkylstyrene, and wherein from about 0.01 mole % to about 60 mole % of the methyl groups present on the benzene ring of the para-alkylstyrene contain a halogen atom. The percentages of para-alkylstyrene and halogenation can vary widely. Different applications may require dramatically different formulations. Generally, the copolymer of the present invention will have from 2 wt % to 20 wt % para-alkylstyrene (preferably para-methylstyrene). In addition, the copolymer of the present invention will have from 0.20 mol % to 3.0 mol % of a halogenated compound, such as bromomethylstyrene.

Typically, low levels of either bromine and/or para-alkylstyrene are used. In one embodiment, para-alkylstyrene (preferably para-methylstyrene) comprises from 5 wt % to 10 wt % of the copolymer. In another embodiment, it is about 5 wt % of the copolymer. In yet another embodiment, a halogenated compound, such as bromomethylstyrene comprises from 0.40 mol % to 3.0 mol % of the copolymer. In yet another embodiment, it comprises from 0.50 mol % to 1.25 mol % of the copolymer. And in yet another embodiment, it is about 0.75 mol % of the copolymer.

The copolymer used in the colorable rubber blends of the present invention is a terpolymer of isobutylene, para-methylstyrene and bromo para-methylstyrene in one embodiment. The copolymer composes from 20 to 100 parts, per hundred parts rubber (phr), of the colorable rubber blend in one embodiment. The copolymer comprises from 30 to 80 phr of the colorable rubber blend in another embodiment.

General Purpose Rubber Component

Desirably, the colorable rubber blends of the present invention contains one or more general purpose rubbers. The term “general purpose rubber” (GPR) includes natural rubber and synthetic rubbers. Suitable synthetic rubbers are homopolymers and copolymers of conjugated dienes which include polybutadiene, polyisoprene, styrene-butadiene rubber, styrene-isoprene rubber, styrene-isoprene-butadiene rubber, isoprene-butadiene rubber, neoprene, polychloroprene, butyl rubber and nitrile rubber as well as mixtures thereof. The Mooney viscosity at 100° C. (ML 1+4) of such rubbers is generally between 20 to 150. (Mooney viscosity as referred to herein is measured in accordance with ASTM D-1646).

The natural rubber for use in the present invention has a Mooney viscosity at 100° C. (ML 1+4) of from 30 to 120 in one embodiment, and from 30 to 65 in another embodiment. Natural rubbers are described in detail by Subramaniam in RUBBER TECHNOLOGY 179-208 (Van Nostrand Reinhold Co. Inc., Maurice Morton, ed. 1987). The bulk of commercially available natural rubber consists of cis-1,4-polyisoprene. Generally between 93 to 95% by weight of natural rubber is cis-1,4-polyisoprene.

Included within the group of natural rubber is Malaysian rubber such as SMR CV, SMR 5, SMR 10, SMR 20, and SMR 50 and mixtures thereof. Oil extended natural rubber may further be used in various grades. The raw rubber portion may be either a latex or remilled-type rubber. Aromatic or non-staining cycloparaffinic oils are typically used at 10, 25 and 30 wt % by weight of the rubber.

Polyisoprene rubber which is essentially identical in structure with natural rubber may also be used. Polyisoprene, like natural rubber, may include all cis-polyisoprene with 1,4-addition structure. In one embodiment, the polyisoprene may differ from natural rubber in relative amounts of 1,4- and 1,3-addition structure. In addition to poly (cis-1,4 isoprene), other forms of polyisoprene may be used—trans-1,4 and trans-3,4 of high purity as well as the poly-1,2 structure such as that obtained in conjunction with the other three structures.

Polybutadiene may also be employed as the general purpose rubber. Polybutadiene, an addition polymerization product, may be a 1,4-addition product and can be of a cis-1,4 or trans-1,4 structure. Participation of a single double bond results in a vinyl or 1,2-addition. The two “1,4” structures contain backbone unsaturation whereas the two 1,2-polybutadienes contain pendant unsaturation. The Mooney viscosity of polybutadiene rubber as measured at 100° C. (ML 1+4) ranges from 40 to 70 in one embodiment, from 45 to 65 in another embodiment, and from 50 to 60 in yet another embodiment.

Further, useful as a general purpose rubber is neoprene, also known as chloroprene. This rubber, composed of 2-chloro-1,3-butadiene units, typically consists of a linear sequence of predominantly trans-1,4 structure with small amounts of cis-1,4, 1,2 and 3,4 polymerization. The trans-1,4 and cis-1,4 structures have backbone unsaturation. The 1,2 and 3,4 structures further often have pendant unsaturation. Such polymers are generally prepared by free-radical emulsion polymerization.

In addition, nitrile rubbers, random emulsion polymers of butadiene and acrylonitrile may be employed. Such polymers are well known in the art and typically vary in acrylonitrile proportions from 15 to 60% by weight.

Further, styrene-butadiene rubber may be used as the general purpose rubber. Such copolymers are well known in the art and consist of styrene units as well as any of the three butadiene forms (cis-1,4 trans-1,4, and 1,2 or vinyl). Such copolymers of styrene and butadiene may be randomly dispersed mixtures of the two monomers or block copolymers. Typically, styrene-butadiene copolymers contain from 10 to 90 wt %, and from 30 to 70 wt % of conjugated diene in another embodiment.

Butyl rubber is used in yet another embodiment of the invention as the GPR. Butyl rubber is produced by the polymerization reaction between isoolefin and a conjugated diene comonomers, thus containing isoolefin-derived units and conjugated diene-derived units. The olefin polymerization feeds employed in connection with the catalyst and initiator system are those olefinic compounds, the polymerization of which are known to be cationically initiated, and are free of aromatic monomers such as para-alkylstyrene monomers. Preferably, the olefin polymerization feeds employed in the present invention are those olefinic compounds conventionally used in the preparation of butyl-type rubber polymers. The butyl polymers are prepared by reacting a comonomer mixture, the mixture having at least (I) a C₄ to C₆ isoolefin monomer component such as isobutylene with (2) a multiolefin, or conjugated diene, monomer component. The isoolefin is in a range from 70 to 99.5 wt % by weight of the total comonomer mixture in one embodiment, and 85 to 99.5 wt % in another embodiment. The conjugated diene component in one embodiment is present in the comonomer mixture from 30 to 0.5 wt % in one embodiment, and from 15 to 0.5 wt % in another embodiment. In yet another embodiment, from 8 to 0.5 wt % of the comonomer mixture is conjugated diene. The isoolefin is a C₄ to C₆ compound such as isobutylene, isobutene or 2-methyl-1-butene, 3-methyl-1-butene, 2-methyl-2-butene, and 4-methyl-1-pentene. The multiolefin is a C₄ to C₁₄ conjugated diene such as isoprene, butadiene, 2,3-dimethyl-1,3-butadiene, myrcene, 6,6-dimethyl-fulvene, hexadiene and piperylene. One embodiment of the butyl rubber polymer of the invention is obtained by reacting 95 to 99.5 wt % of isobutylene with 0.5 to 8 wt % isoprene, or from 0.5 wt % to 5.0 wt % isoprene in yet another embodiment.

In one embodiment, the butyl rubber has an isobutylene content of from 95 to 99.5 wt %. The preferred Mooney viscosity of the butyl rubber useful in the invention as measured at 125° C. (ML 1+4) range from 20 to 80 in one embodiment, from 25 to 55 in another embodiment, and from 30 to 50 in yet another embodiment.

In an embodiment of the colorable blend, the GPR comprises from 10 to 90 phr of the blend, is selected from the group of butyl rubber, polybutadiene, polyisoprene, styrene-butadiene rubber, styrene-isoprene-butadiene rubber, isoprene-butadiene rubber, ethylene-propylene diene rubber, or blends thereof. In yet another embodiment, the colorable rubber blends will contain from 30 to 80 phr of the GPR.

Filler Component

Silica is preferred as the filler, however other non-black fillers such as clays, talcs and other mineral fillers may be used. In addition, the remaining components of the final blend are selected on the basis that they will not interfere with the colorable nature of the elastomer. Non-black fillers are described in detail by M. P. Wagner, in RUBBER TECHNOLOGY 86-104 (Chapman & Hall 1995).

The silica used in the colorable rubber blends of the present invention is preferably precipitated silica. Also, the precipitated silica composes from 30 to 80 parts of the colorable rubber blend in one embodiment. In another embodiment, the silica composes from 40 to 70 parts.

The colorable rubber compounds of the present invention are useful in making colored elastomeric products capable of meeting current performance requirements. These colorable compounds were produced by replacing carbon black filler with a non-staining mineral filler such as, but not limited to, fumed or precipitated silicas, clays, talcs, calcium carbonates, aluminum oxides, titanium oxides, silicon oxides and zinc oxides. The mineral filler must reinforce the polymer system and not inhibit pigmentation to be effective. In addition, the remaining components of the colorable compound were selected on the basis that they will not interfere with the colorable nature of the elastomer. The cured, colorable compounds of the present invention still have the same dynamic and physical properties that meet the performance demands of current black-colored tire treads.

As stated above, all components of the colorable elastomeric blends must be carefully selected so that they will not interfere with the colorability of the blend. For example, the elastomers, fillers, processing aids, antidegradants and curatives should not discolor the blend during the formation of the elastomeric blend. Furthermore, the components should not discolor the elastomeric blend as a result of exposure to light (including UV), heat, oxygen, ozone and strain.

The fillers of the present invention may be any size and typically range, e.g., in the tire industry, from about 0.0001 to about 100 microns. As used herein, silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and the like.

Silane Coupling Agents

One or more coupling agents are used in the elastomeric blends of the present invention. In one embodiment, the coupling agent is a bifunctional organosilane coupling agent. By an “organosilane coupling agent” is meant any silane coupled filler and/or cross linking activator and/or silane reinforcing agent known to those skilled in the art including. The silane coupling agent used in the colorable rubber blends of the present invention is an organosilane-coupling agent in one embodiment. In one embodiment, the organosilane-coupling agent comprises from 0.1 to 20 wt % of the blend based on the weight of the blend, and from 2 to 15 wt % of the blend, based on the weight of the blend in another embodiment. In yet another embodiment, it comprises from 5 to 10 wt % of the blend.

In another embodiment, the coupling agent is from 2 to 15 wt % of the blend based on the weight of the GPR/silicon/silane masterbatch or the BIMS/silicon/silane masterbatch, or from 5 to 10 wt % of each masterbatch in another embodiment. The masterbatches are then mixed in various proportions depending on the application desired. In one embodiment, the GPR/silicon/silane masterbatch is from 30 to 70 wt % of the blend, and from 40 to 60 wt % in another embodiment. The final wt % of silane in the blend in this embodiment will be from 2 to 15 wt % based on the weight of the blend, or from 5 to 10 wt % in another embodiment.

Organosilane coupling agents, or “silanes”, suitable for use in the present invention can be described generally by the following formulas (1):

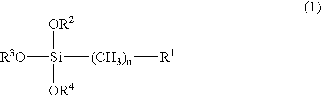

wherein R¹ can be a vinyl, sulfur (thiol), amine, alkylthiol, alkylamine, alkylsilane, alkoxysilane, methacrylate, nitroso, or halogen group; R² through R⁴ can be the same or different, and can be an alkyl, aryl alkyl group, or a phenyl group, and n is an integer from 1 to 10, desirably from 2 to 4. In one embodiment, the silane of the invention is at least a di-functional silane, wherein two moieties are available to bond or closely associate with the copolymer or GPR. Specific embodiments of the silane coupling agent are shown in formulas (2) through (4):

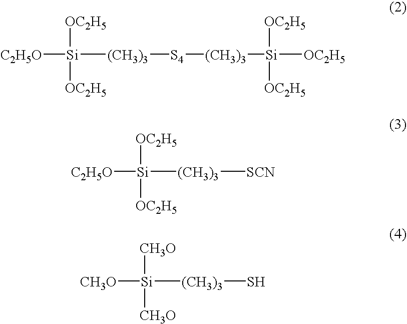

wherein (2) is bis(3-triethoxysilylpropyl) tetrasulfide, (3) is 3-thiocyanatopropyl-triethoxy silane, and (4) is 3-mercaptopropyl-trimethoxy silane. Other suitable organosilane coupling agents including, but are not limited to, vinyl triethoxysilane, vinyl-tris-(beta-methoxyethoxy)silane, methacryloylpropyltrimethoxysilane, gamma-amino-propyl triethoxysilane (sold commercially as “A 1100” by Witco), gamma-mercaptopropyltrimethoxysilane bis(2-triethoxysilyl-ethyl) tetrasulfide, bis(3-trimethoxysilyl-propyl) tetrasulfide, bis(2-trimethoxysilyl-ethyl) tetrasulfide, 3-mercaptopropyl-triethoxy silane, 2-mercaptopropyl-trimethoxy silane, 2-mercaptopropyl-triethoxy silane, 3-nitropropyl-trimethoxysilane, 3-nitropropyl-triethoxysilane, 3-chloropropyl-trimethoxysilane, 3-chloropropyl-triethoxysilane, 2-chloropropyl-trimethoxysilane, 2-chloropropyl-triethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropyl-benzothiazole tetrasulfide, 3-trimethoxysilylpropyl-methacrylate monosulfide, 3-trimethoxysilylpropyl-methacrylate monosulfide, and the like, and mixtures thereof. Suitable silane coupling agents are further described in U.S. Pat. Nos. 5,827,912, 5,780,535, 6,005,027, 6,136,913, and 6,121,347. In one embodiment, the silane is selected from the group consisting of bis-(3(triethoxysilyl)-propyl)-tetrasulfane (sold commercially as “Si 69” by Degussa), 3-thiocyanatopropyl-triethoxy silane (“Si 264”), and is 3-mercaptopropyl-trimethoxy silane (“Si 189”).

Generally, polymer blends, e.g., those used to produce tires, are crosslinked. It is known that the physical properties, performance characteristics, and durability of vulcanized rubber compounds are directly related to the number (crosslink density) and type of crosslinks formed during the vulcanization reaction. See, e.g., W. F. Helt, B. H. To and W. W. Paris in The Post Vulcanization Stabilization for NR, RUBBER WORLD, 18-23 (1991). Generally, polymer blends may be crosslinked by adding curative molecules, for example sulfur, metal oxides (i.e., zinc oxide), organometallic compounds, radical initiators, etc. followed by heating. This method may be accelerated and is often used for the vulcanization of elastomer blends. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous curatives are known in the art and include, but are not limited to, the following: zinc oxide, stearic acid, tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate (sold commercially as DURALINK™ HTS by Flexsys), 2-(morpholinothio) benzothiazole (MBS or MOR), blends of 90% MOR and 10% MBTS (MOR 90), and N-oxydiethylene thiocarbamyl-N-oxydiethylene sulfonamide (OTOS) zinc 2-ethyl hexanoate (ZEH). In addition, various vulcanization systems are known in the art. For example, see Formulation Design and Curing Characteristics of NBR Mixes for Seals, RUBBER WORLD 25-30 (1993).

In one embodiment, it is desirable to allow the silica, rubber, and silane to mix thoroughly before adding other compounding ingredients such as zinc cure additives. Processing aids such as plasticizers may be present in the first mixing stage, but are desirably added in a later mixing stage after the silane is well dispersed in the GPR and the copolymer.

Colorable Blend

The colorable blend of the invention is formed by mixing or blending the various components by most any means known to those skilled in the art. In one embodiment, the colorable rubber blends of the present invention contain from 10 to 100 parts, per hundred parts rubber (phr), of the copolymer of a C₄ to C₇ isoolefin and a para-alkylstyrene (copolymer); from 10 to 100 phr silica; and from 0.1 to 20 wt % of silane in one embodiment, and from 2 to 15 wt % of a silane coupling agent in another embodiment, based on the weight of the blend. Furthermore, in another embodiment, the colorable rubber blends of the present invention contain from 10 to 90 phr of the GPR, including butyl rubber, polybutadiene, polyisoprene, styrene-butadiene rubber, styrene-isoprene-butadiene rubber, isoprene-butadiene rubber, ethylene-propylene diene rubber neoprene, polychloroprene, nitrile rubber, or blends thereof. In yet another embodiment, the colorable rubber blends will contain from 30 to 80 phr of the GPR.

The copolymer used in the colorable rubber blends of the present invention is a terpolymer of isobutylene, para-methylstyrene and bromo para-methylstyrene in one embodiment as described above. The copolymer comprises from 20 to 100 phr of the colorable rubber blend in one embodiment. The copolymer composes from 30 to 80 phr of the colorable rubber blend in yet another embodiment.

In another embodiment, the blend contains from 10 to 100 phr of the copolymer of a C₄ to C₇ isoolefin and a para-alkylstyrene, from 10 to 100 phr of the general purpose rubber, from 10 to 100 phr of the silica; and from 0.1 to 20 wt % of the coupling agent, based on the weight of the blend.

The blends produced in accordance with the present invention may also contain other components and additives customarily used in rubber mixes, such as effective amounts of nondiscolored and nondiscoloring processing aids, pigments, accelerators, crosslinking and curing materials, antioxidants, antiozonants, fillers and naphthenic, aromatic or paraffinic extender oils if the presence of an extension oil is desired. Processing aids include, but are not limited to, plasticizers, tackifiers, extenders, chemical conditioners, homogenizing agents and peptizers such as mercaptans, petroleum and vulcanized vegetable oils, waxes, resins, rosins, and the like. Accelerators include amines, guanidines, thioureas, thiazoles, thiurams, sulfenamides, sulfenimides, thiocarbamates, xanthates, and the like. Crosslinking and curing agents include sulfur, zinc oxide, and fatty acids. Peroxide cure systems may also be used. Fillers include mineral fillers such as silica and clay as described above.

The components of the colorable blend may be mixed by any standard means known to those skilled in the art, such as by, for example, a BANBURY™-type mixer. In one embodiment, the components are mixed in a three stage process, whereby the copolymer and silica are first mixed with the at least one coupling agent (masterbatch mixing). In a separate mixing stage, the GPR and silica are mixed. In this embodiment, there is a silane coupling agent mixed in either the copolymer/silica mixture or the GPR/silica mixture. Finally, the two masterbatches of copolymer/silica/(silane when present) and GPR/silica/(silane when present) are mixed to form the blend of the invention. There may be more than one coupling agent present.

In another embodiment of the invention, the copolymer is first mixed with the silica and the silane coupling agent. In a separate mixing stage, the GPR is mixed with the silica and silane coupling agent. The two masterbatches of copolymer/silica/silane and GPR/silica/silane are then mixed together. The silane coupling agents in the two stages may be the same or different, and there may be more than one coupling agent present.

The masterbatch mixing of the BIMS/silica/silane and GPR/silica/silane should be separate in a desirable embodiment, but may be carried out in any sequence, either concurrently or spaced apart in time. In a final mixing stage, the BIMS/silica and GPR/silica mixtures are mixed together with other crosslinking or curing agents. Typical mixing times for each stage range from 4 to 10 minutes for the masterbatch mixing, and from 2 to 5 minutes for the final stage mixing.

The present invention provides improved elastomeric blends comprising a copolymer of a C₄ to C₇ isoolefin and a para-alkylstyrene, silica and, optionally, one or more coupling agents. These blends exhibit improved properties including improved abrasion resistance, reduced cut growth, improved adhesion, reduced heat build-up, and retention of mechanical properties during severe heat build-up conditions such as those experienced in “run-flat” tires and engine mounts for transportation vehicles. The substantially isoolefin (isobutylene) backbone elastomer is a key element in that it imparts a self-limiting heat build-up. At lower temperatures, these elastomers exhibit high damping behavior which dissipates mechanical energy in the form of heat. However, as the elastomer heats up, the damping behavior diminishes and the behavior of the elastomer in more elastic and less dissipative.

The materials are mixed by conventional means known to those skilled in the art, in a single step or in stages. For example, the elastomers of this invention can be processed in one, two, or three steps. In one embodiment, silica and optionally the silane, are mixed with a copolymer of a C₄ to C₇ isoolefin and a para-alkylstyrene to form a silica/copolymer blend; a general purpose rubber is separately mixed with silica and, when present, one or more silane coupling agents, to form a silica/general purpose rubber blend; and, finally, the silica/copolymer blend is mixed with the silica/general purpose rubber blend. Sulfur may be added at any of the stages.

In a more preferred embodiment, antioxidants, antiozonants and processing materials are added in a stage after silica and silane have been processed with the rubber, and zinc oxide is added at a final stage to maximize compound modulus. Thus, a two to three (or more) stage processing sequence is desirable. Additional stages may involve incremental additions of filler and processing oils.

Test Methods

Shore Hardness. DIN 53505/ISO R 868/ASTM 2240.

Modulus. ASTM D 412-83.

Tensile Strength. ASTM D 412-83.

Elongation at Break. ASTM D 412-83.

Mooney Viscosity. Cure properties were measured using a MDR 2000 at the indicated temperature and 0.5 degree arc. Test specimens were cured at the indicated temperature, typically from 150° C. to 160° C., for a time (in minutes) corresponding to T90+appropriate mold lag. When possible, standard ASTM tests were used to determine the cured compound physical properties. Stress/strain properties (tensile strength, elongation at break, modulus values, energy to break) were measured at room temperature using an Instron 4202 or Instron 4204. Shore A hardness was measured at room temperature by using a Zwick Duromatic.

Dynamic Properties. Dynamic properties (G*, G′, G″ and Tan δ, wherein G″/G′ equals Tan δ) were determined using a MTS 831 mechanical spectrometer for pure shear specimens (double lap shear geometry) at temperatures of −20° C., 0° C. and 60° C. using a 1 Hz frequency at 0.1, 2 and 10% strains. Temperature-dependent (−80° C. to 60° C.) dynamic properties were obtained using a Rheometrics ARES. A rectangular torsion sample geometry was tested at 1 Hz and 2% strain. Values of G″ or Tan δ measured in the range from −10° C. to 10° C. in laboratory dynamic testing can be used as predictors of tire wet traction for carbon black-filled BR/sSBR (styrene-butadiene rubber) compounds. Temperature-dependent (−90° C. to 60° C.) high-frequency acoustic measurements were performed at Sid Richardson Carbon Company using a frequency of 1 MHz and ethanol as the fluid medium.

Monsanto Fatigue-to-Failure Test. ASTM D 4482-85.

De Mattia Cut-Growth. ASTM D 430-73.

Ozone resistance. ASTMD 1171-83/DIN 53509.

### EXAMPLES

The Y-Mixing step is as follows: the EXXPRO™/silica masterbatch (with or without added silane coupling agent) is mixed for a period of from 3 to 10 minutes in one embodiment, from 5 to 8 minutes in another embodiment, at a temperature of from 130° C. to 170° C. in one embodiment, from 145° C. to 155° C. in another embodiment. The GPR/silica masterbatch, with or without silane coupling agent, is mixed for a period of from 3 to 10 minutes in one embodiment, from 5 to 8 minutes in another embodiment, at a temperature of from 130° C. to 170° C. in one embodiment, from 145° C. to 155° C. in another embodiment. The two masterbatches are then mixed together in a final mixing operation together with any curatives at a temperature of from 90° C. to 120° C. in one embodiment, from 105° C. to 115° C. in another embodiment, from 2 to 4 minutes in one embodiment, or from 1.5 to 2.5 minutes in another embodiment.

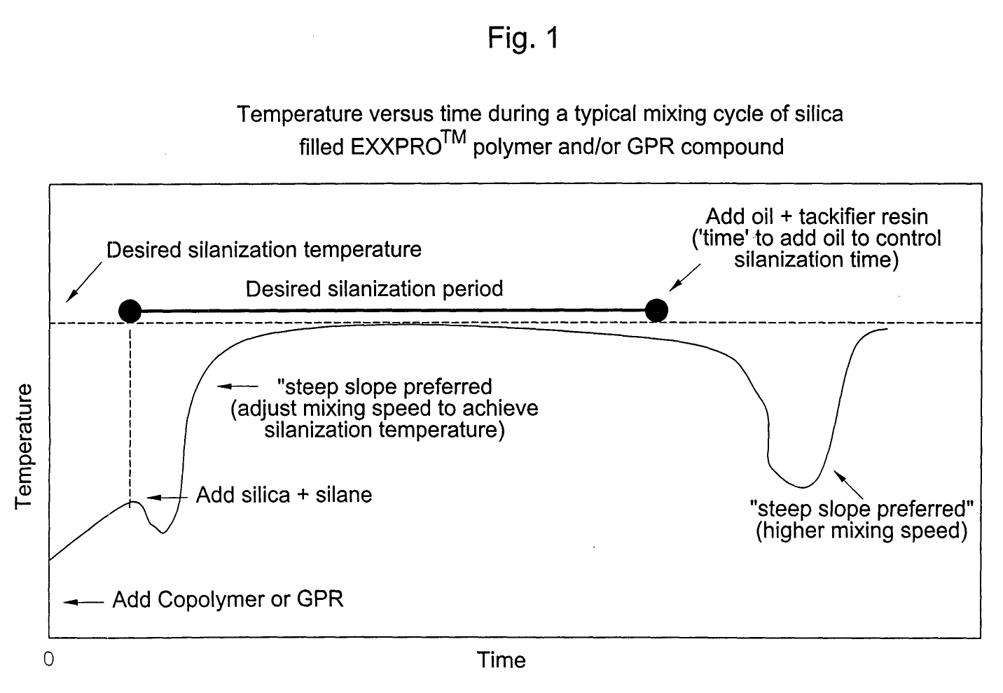

The following examples A-D describe the coupling methods and the end blends obtained from the methods of the invention. In order to facilitate silanization of silica during mixing, one has to use the mixer not only as a device for incorporating the filler and other additives into the polymer but as a reactor. FIG. 1 shows the temperature versus time during a typical mixing cycle of EXXPRO™ polymer and/or GPR with silica. For the silane coupling agents used in our study, between 145° C.-165° C. silanization temperature and 2 to 4 minutes silanization period is necessary.

Samples A-C were mixed as follows: the GPR and BIMS components in the mixer were set at a temperature of about 120° C. and a rotor speed of about 60 rpm. After one minute of mixing, silica was added along with the silane, and the mixing was increased to about 95 rpm. This was continued for about 3 minutes or until the temperature reached 150° C. At this point, oil and tackifier resin was added to the blend, and mixed further for 2-3 minutes until the temperature reached 150° C.

For Sample D, the Y-mixing steps were used, in which a GPR masterbatch and BIMS masterbatch were mixed separately as for the Samples A-C. Then, the two masterbatches were mixed at a 50:50 wt % ratio. The temperature was maintained at about 150° C. for about 3 minutes of mixing. All the blends are finalized by incorporating any curatives either via open mill or via mixing again at a temperature of not more than 120° C.

Table 1 describes the various components used in the Examples and the corresponding trade names. Table 2 shows the effect of silane coupling agents on the curing, physical and dynamic properties of silica (ZEOPOL™ 8745) filled EXXPRO™ 90-10 polymer and compared them with EXXPRO™ polymer filled with N220 and N660 carbon black. These compounds all contain 40 phr of filler and 20 phr of oil. The curatives used for all the compounds include 4 phr of stearic acid, 2 phr of ZnO and 2.5 phr of zinc dimethyl dithiocarbamate. Three types of silane coupling agents (in molar equivalent amount, i.e. 3 phr Si 69, 1.5 phr Si 264 and 1.1 phr Si 189) were used.

It can be seen that the use of silane coupling agent reduces the Mooney viscosity, except for the case of Si 189. Due to the stronger filler-filler interaction of silica in comparison to carbon black, the Mooney viscosity of silica filled compounds is usually greater than those filled with carbon black. The addition of silane normally reduces Mooney viscosity. While not wishing to be bound by theory, in the case of Si 189, the high Mooney viscosity is consistent with the silica acting as crosslink sites and effectively extend the molecular weight of the EXXPRO™ polymer.

The large reduction in T_{c}90 due to the use of silane coupling agent is also evident from the data. Silane coupling agent increases the curing rate of silica filled EXXPRO™ compound. While not wishing to be bound by theory, the increased cure rate may result from a smaller amount of coupling agent being adsorbed onto the now silane coated silica filler.

The use of Si 189 significantly increases the 100% and 300% modulus, which is consistent with a strong interaction between the silica and EXXPRO™ polymer matrix. The ratio of 300% modulus to 100% modulus follows the order Si 189>Si 69>>Si 264. This is consistent with the observation that Si 189 is most effective in promoting silica/BIMS polymer interaction while Si 264 is least effective. It should be noted that these silica filled compounds achieve similar or better reinforcing properties as N220 or N660 carbon black filled EXXPRO™ polymer.

The use of silane coupling agents also improves the dynamic performance of silica filled EXXPRO™ polymer. Dynamic property studies show that when silane coupling agent is used the Tan 6 value (measured at 20 Hz) at −20° C. and 0° C. increases while the Tan 6 value (measured at 20 Hz) at 60° C. decreases. The silica filled compound might be expected to have comparable wet grip and lower rolling resistance than the N220 or N660 carbon black filled EXXPRO™ polymer as can be evidenced from the similar low-temperature Tan δ value and lower high-temperature Tan δ value. Data for Tan δ as a function of temperature of silica filled EXXPRO™ polymer without any silane, with Si 69 and that of carbon black filled 50/50 EXXPRO™ polymer/GPR compound are shown in Table 5.

The study on silica filled EXXPRO™ polymer indicates that the use of silane coupling agent further improves the dispersion of the “high-dispersion” silica in EXXPRO™ compounds. This releases the “trapped” polymer (that acts as a glass at low temperature) in the filler network and enables them to dissipate energy, leading to higher Tan δ (better wet-grip) at low temperature. Silane coupling agent can also promote interaction between silica and EXXPRO™ polymer. Unlike carbon black, the silane induced interaction between silica and EXXPRO™ polymer remains intact as temperature increases. This enables the silica filled compound to maintain its elasticity and hence low rolling resistance as temperature increases. In contrast to carbon black reinforced EXXPRO™ polymer, Mooney viscosity of silica filled EXXPRO™ polymer decreases much less as temperature increases (Table 4A and 4B). This indicates that the interaction between silica and EXXPRO™ polymer is affected much at temperatures up to 100° C.

Table 4A and 4B compares the various tire sidewall performances of silica filled EXXPRO™ polymer (Sample B), silica filled GPR (Sample C), silica filled EXXPRO™ polymer/GPR blend via normal mixing (Sample A) and silica filled EXXPRO™ polymer/GPR blend via Y-mixing (Sample D).

The results in Table 4B show that the curing characteristics, ozone resistance as well as fatigue cut-growth and fatigue-to-failure resistance of the silica filled EXXPRO™ polymer and silica filled GPR compounds differ greatly, with the latter compound having faster cure rate, better fatigue but much worse ozone resistance. On the other hand, the silica filled EXXPRO™ polymer has much better dynamic properties (higher Tan δ at low temperature and lower Tan δ at high temperature) compared to the silica filled GPR compound. When both the BIMS copolymer and the GPR component are present in the blend, the properties generally lie between that of the silica filled copolymer and GPR if a normal mixing cycle (where both elastomers and the filler are mixed together in a single step) is adopted. We can observe from Table 4B that the mixing procedure has a major impact on the performance of silica filled copolymer/GPR blends. Compared with the compound derived from the normal mixing cycle (Sample A) the Y-mixed compound (Sample D) has much better Monsanto fatigue-to-failure and De Mattia cut-growth resistance. The two-step Y-mixing also leads to a much better ozone resistance of the compound. This most likely accounts for the improved fatigue and ozone resistance observed. Furthermore, the mixing procedure also has a major influence on the distribution of the silica filler in the different elastomer phase.

The colorable elastomeric blends of the present invention exhibit improved hysteretic properties, traction, heat stability and retention of properties upon aging to known colorable elastomers. This results in colorable rubber blends which have sufficient properties to function as a reinforcing member in an automobile tire. The colorable rubber will allow a manufacturer to produce a tire with improved product appearance.

More particularly, silica filled BIMS has good potential for developing tires that has good sidewall aspects whether white, colored or black. Tires made with silica filled BIMS polymer as sidewall will also have better dynamic performance than that made with convention all carbon black filled GPR compound. Generally when used in tire compounds, BIMS is blended with GPR in order to achieve higher “green” (pre-cure) tack for easier tire build and better compound to compound adhesion during vulcanization.

The elastomeric blends of the present invention are useful in a variety of applications, particularly pneumatic tire components (e.g., tire sidewalls), hoses, belts, solid tires, footwear components, rollers for graphic arts applications, vibration isolation devices, pharmaceutical devices, adhesives, sealants, protective coatings and bladders for fluid retention and curing purposes.

While certain representative embodiments and details have been shown for the purposes of illustrating the invention, it will be apparent to those skilled in the art that various changes in the process and products disclosed herein may be made without departing from the scope of the invention, which is defined in the appended claims.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 1
Components used in the Examples

| Compound | Description | Commercial Source |
|---|---|---|
| BUDENE 1207 | cis-polybutadiene | Goodyear Chemical |
| | | Company (Akron, OH) |
| DHT-4A-2 | magnesium aluminum | Kyowa Chemical Ind., |
| | hydroxide carbonate | Co. |
| KORESIN ™ | Butylphenol acetylene resin | BASF (Belgium) |
| MBTS | 2,2'-Dibenzothiazyldisulphide | Flexsys (Belgium) |
| N220 | carbon black, intermediate | Degussa (Germany) |
| | super abrasion furnace | |
| SMR CV 50 | standard Malaysian Natural | Safic |
| | Rubber | |
| N660 | carbon black, general purpose | Degussa (Germany) |
| | furnace | |
| PEG | polyethylene glycol | Union Carbide BNLX |
| | | (Belgium) |
| SILANE 69, | bis-(3(triethoxysilyl)-propyl)- | Degussa (Germany) |
| or Si 69 | tetrasulfane | |
| Si 189 | Gamma-mercapto | Witco (Europe) S.A. |
| | propyltrimethoxy silane | (Germany) |
| Si 264 | 3-thiocyanatepropyl- | Degussa (Germany) |
| | triethoxysilane | |
| STRUCTOL ™ | blend of aliphatic-aromatic- | Schill & Seilacher |
| | naphthenic resins | (Germany) |
| VN3 | precipitated amorphous silica | Degussa-Huls |
| VULTAC ™ 5 | alkylphenol disulfide | Sovereign Chemical |
| | | Co. (Akron, OH) |
| WINGTACK ™ | hydrocarbon resin | Goodyear Chemical |
| EXTRA | | Company (Akron, OH) |
| ZEOPOL ™ | precipitated amorphous silica, | Huber Corporation, |
| 8745 | SG 2.0, surface area 165-195, | Havre De Grace USA |
| | ph 6.4 | |

TABLE 2
Comparison of the Mooney viscosity as well as curing, physical and dynamic performance
of various EXXPRO ™ mixtures.

| | EXXPRO ™ 10-90¹ | | | | | | |
|---|---|---|---|---|---|---|---|
| | | N220 | N660 | | ZEOPOL ™ + | ZEOPOL ™ + | ZEOPOL ™ + |
| | | carbon | carbon | ZEOPOL ™ | silane | silane | silane |
| Property | No filler | black | black | (no silane) | (Si 69) | (Si 189) | (Si 264) |
| Modulus 100% (MPa) | 0.4 | 1.6 | 1.0 | 0.9 | 1.0 | 1.5 | 0.9 |
| Modulus 300% (MPa) | 0.8 | 7.7 | 4.6 | 2.2 | 5.0 | 8.0 | 4.0 |
| Mod 300%/Mod 100% | 2.0 | 4.8 | 4.6 | 2.4 | 5.0 | 5.3 | 4.4 |
| Tensile Strength (MPa) | 1.3 | 11.2 | 9.4 | 12.3 | 10.0 | 8.7 | 12.3 |
| Elongation at break (%) | 460 | 420 | 540 | 765 | 465 | 315 | 595 |
| Mooney Viscosity | 33 | 50 | 45 | 76 | 68 | 76 | 65 |
| ML(1 + 4) 100° C. | | | | | | | |
| Hardness Shore A | 22 | 49 | 41 | 40 | 41 | 43 | 38 |
| T_{c}90, mins. | 0.87 | 0.77 | 0.73 | 8.5 | 2.5 | 4.3 | 5.5 |
| Tan δ (−20° C.) | 1.55 | 0.96 | 1.2 | 0.92 | 1.12 | 1.17 | 1.05 |
| Tan δ (0° C.) | 1.15 | 0.77 | 0.94 | 0.66 | 0.86 | 0.86 | 0.76 |
| Tan δ (60° C.) | 0.59 | 0.17 | 0.16 | 0.14 | 0.10 | 0.06 | 0.11 |

¹All mixtures contain 20 phr SUNPAR ™ 2280 (highly saturated parrafinic oil, Sunoco, Philadelphia PA) and cured using ZnO (1 phr), stearic acid (1 phr), MTBS (1.2 phr), sulfur (0.5 phr), VULTAC ™ 5 (0.5 phr), DHT-4A-2 (0.5 phr).

TABLE 3
Mooney Viscosity ML(1 + 4) measured at various temperatures
of the components.

| Mooney | | | | | |
|---|---|---|---|---|---|
| Viscosity | | | | ZEOPOL ™ + | |
| ML(1 + 4) | No filler | N220 | N660 | Si 69 | VN3 + Si 69 |
| 40° C. | 57 | 76 | 71 | 79 | 80 |
| 60° C. | 53 | 69 | 65 | 76 | 76 |
| 100° C. | 33 | 50 | 45 | 71.5 | 68 |

TABLE 4A
Compositions of Samples A-D

| | A | B | C | D |
|---|---|---|---|---|
| Masterbatch: | | | | |
| Natural rubber SMR CV 50 | 10 | — | 20 | 10 |
| BUDENE 1207 | 40 | — | 80 | 40 |
| EXXPRO ™ 90-10 | 50 | 100 | — | 50 |
| ZEOPOL ™ 8745 | 40 | 40 | 40 | 40 |
| Silane 69 | 1.5 | 1.5 | 1.5 | 1.5 |
| Paraffinic mineral oil | 20 | 20 | 20 | 20 |
| Polyethylene glycol | 1 | 1 | 1 | 1 |
| KORESIN ™ | 3 | 3 | 3 | 3 |
| WINGTACK ™ EXTRA | 3 | 3 | 3 | 3 |
| STRUKTOL ™ 40 MS | 3 | 3 | 3 | 3 |
| Finalization: | | | | |
| DHT-4A-2 | 0.5 | 0.5 | 0.5 | 0.5 |
| sulfur | 0.3 | 0.3 | 0.3 | 0.3 |
| VULTAC ™ 5 | 0.5 | 0.5 | 0.5 | 0.5 |
| Stearic acid | 1 | 1 | 1 | 1 |
| Zinc oxide | 1 | 1 | 1 | 1 |
| MBTS | 1.2 | 1.2 | 1.2 | 1.2 |

TABLE 4B
Properties of the Samples A-D

| Property | A | B | C | D |
|---|---|---|---|---|
| Mooney viscosity, ML(1 + 4) 100° C. | 53.0 | 55.1 | 52.5 | 40.8 |
| Rheometer, MDR (Arc. 0.5°, 180° C.) | | | | |
| ML ( dN.m) | 1.79 | 1.79 | 1.95 | 1.34 |
| MH ( dN.m) | 6.07 | 5.96 | 6.80 | 5.52 |
| Tₛ2, Scorch ( mins.) | 3.76 | 6.36 | 2.53 | 4.04 |
| T_{c}90, Cure ( mins.) | 9.5 | 12.6 | 6.6 | 9.3 |
| DYNAMIC PROPERTIES (DMTA): | | | | |
| TAN δ (20 Hz/0° C.) | 0.56 | 1.00 | 0.24 | 0.56 |
| TAN δ (20 Hz/60° C.) | 0.19 | 0.15 | 0.22 | 0.17 |
| Physical properties: | | | | |
| Hardness Shore A (3 sec.) | 35.9 | 39.5 | 35.8 | 33.5 |
| Modulus 100% (MPa) | 0.9 | 1.2 | 0.6 | 0.8 |
| Modulus 300% (MPa) | 3.5 | 5.3 | 1.7 | 2.5 |
| Modulus 300%/Modulus 100% | 3.9 | 4.4 | 2.8 | 3.1 |
| Tensile Strength (MPa) | 5.9 | 8.0 | 4.9 | 5.4 |
| Elongation at Break (%) | 450 | 415 | 595 | 550 |
| Monsanto Fatigue-to-Failure Test: | 25.6 | 12.4 | 119.8 | 57.3 |
| 140% elongation (kilo-cycle) | | | | |
| De Mattia Cut-Growth (mm): | | | | |
| 10 KC | 7 | 5.5 | 2 | 2.5 |
| 30 KC | 16 | 12 | 2 | 3 |
| 50 KC | 22.5 | 17 | 2.5 | 3.5 |
| 100 KC | 25 | 25 | 4 | 4 |
| 250 KC | 25 | 25 | 6.5 | 6 |
| 500 KC | 25 | 25 | 10 | 7.5 |
| 1000 KC | 25 | 25 | 12.5 | 8.5 |
| OZONE RESISTANCE: 200 pphm/50% | | | | |
| RH/40° C./120% elongation. | | | | |
| Color | Black | Black | Brown | Black |
| Hours to first cracks | 16 | >50 | 0.5 | >50 |
| Hours to break | 20 | >50 | 12 | >50 |

TABLE 5
Tan δ values of silica filled EXXPRO ™ samples with and
without added silane, carbon black, and the EXXPRO ™/GPR
sample.
40 phr ZEOPOL ™ 8745 with EXXPRO ™, Tan δ at 20 Hz

| | −20° C. | 0° C. | 60° C. |
|---|---|---|---|
| 50/50 | 0.72 (0.76)² | 0.53 (0.65) | 0.17 (0.20) |
| EXXPRO ™/GPR | | | |
| and black sidewall | | | |
| compound¹ | | | |
| No silane | 0.92 (1.16) | 0.66 (0.79) | 0.14 (0.17) |
| Si 69 | 1.12 (1.22) | 0.86 (0.91) | 0.10 (0.15) |
| 2 × Si 69³ | 1.16 | 0.94 | 0.10 |

¹EXXPRO ™ 8745 (ExxonMobil Chemical Company, Houston TX).
²Second trial.
³2 × Si 69 means twice the amount of Si 69. The usual amount is 1.5 phr, as in Table 4A, 2 × is 3 phr.

We claim:

1. A process for preparing a blend comprising:
a) mixing a copolymer of a C₄ to C₇ isoolefin and a para-alkylstyrene with silica;
b) separately mixing a general purpose rubber with silica, wherein one or more silane coupling agents is mixed with at least one of the silica/copolymer or silica/general purpose rubber mixtures; and
c) mixing the silica/copolymer mixture with the silica/general purpose rubber mixture to form the blend.

2. The process of claim 1, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber, neoprene, polychloroprene, butyl rubber, nitrile rubber and blends thereof.

3. The process of claim 2, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber and blends thereof.

4. The process of claim 3, wherein the general purpose rubber is selected from the group consisting of natural rubber, polybutadiene, styrene-butadiene rubber and blends thereof.

5. The process of claim 1, wherein the C₄ to C₇ isoolefin is isobutylene.

6. The process of claim 5, wherein the para-alkylstyrene is para-methylstyrene.

7. The process of claim 1, wherein the copolymer is a terpolymer of isobutylene, para-methylstyrene and bromo para-methylstyrene.

8. The process of claim 1, wherein the blend is colorable.

9. The process of claim 1, wherein the blend is substantially free of carbon black and antioxidant.

10. The process of claim 1, wherein the blend comprises:
a) from 10 to 100 phr of the copolymer of a C₄ to C₇ isoolefin and a para-alkylstyrene;
b) from 10 to 100 phr of the general purpose rubber;
c) from 10 to 100 phr of the silica; and
d) from 0.1 to 20 wt % of the coupling agent, based on the weight of the blend.

11. The process of claim 10, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber, neoprene, polychloroprene, butyl rubber, nitrile rubber and blends thereof.

12. The process of claim 10, wherein the copolymer is a terpolymer of isobutylene, para-methylstyrene and bromo para-methylstyrene.

13. The process of claim 12, wherein the blend comprises from 20 to 100 phr of a terpolymer of isobutylene, para-methylstyrene and bromo para-methylstyrene.

14. The process of claim 10 wherein the silica is precipitated silica.

15. The process of claim 14, wherein the blend comprises from 30 to 80 phr of precipitated silica.

16. The process of claim 10, wherein the coupling agent is an organosilane coupling agent.

17. The process of claim 16, wherein the blend comprises from 2 to 15 wt % of an organosilane-coupling agent, based on the weight of the blend.

18. The process of claim 1, wherein the coupling agent is an organosilane coupling agent selected from the group consisting of bis-(3(triethoxysilyl)-propyl)-tetrasulfane, gamma-mercaptopropyltrimethoxysilane, 3-thiocyanatopropyl-triethoxy silane and blends thereof.

19. The blend produced by the process of claim 1.

20. A process for preparing a blend comprising:
a) mixing a general purpose rubber with silica and one or more coupling agents to form a silica/general purpose rubber mixture; and
b) mixing the silica/general purpose rubber mixture with a copolymer of a C₄ to C₇ isoolefin and a para-alkylstyrene to form the blend.

21. The process of claim 20, wherein the amount of time the silica/general purpose rubber blend is mixed with the copolymer of a C₄ to C₇ isoolefin and a para-alkylstyrene is varied to control the silica dispersion between the general purpose rubber and the copolymer in the elastomeric blend.

22. The process of claim 20, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber, neoprene, polychloroprene, butyl rubber, nitrile rubber and blends thereof.

23. The process of claim 22, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber and blends thereof.

24. The process of claim 23, wherein the general purpose rubber is selected from the group consisting of natural rubber, polybutadiene, styrene-butadiene rubber and blends thereof.

25. The process of claim 20, wherein the C₄ to C₇ isoolefin is isobutylene.

26. The process of claim 25, wherein the para-alkylstyrene is para-methylstyrene.

27. The process of claim 20, wherein the copolymer is a terpolymer of isobutylene, para-methylstyrene and bromo para-methylstyrene.

28. The process of claim 20, wherein the blend is colorable.

29. The process of claim 20, wherein the blend is substantially free of carbon black and antioxidant.

30. The elastomeric blend produced by the process of claim 20.

31. The process of claim 1, further comprising adding sulfur in step b), step c), or both.

32. A process for preparing a blend comprising:
a) mixing a copolymer of a C₄ to C₇ isoolefin and a para-alkylstyrene with silica and one or more coupling agents to form a silica/copolymer mixture;
b) separately mixing a general purpose rubber with silica and one or more coupling agents to form a silica/general purpose rubber mixture; and
c) mixing the silica/copolymer mixture with the silica/general purpose rubber mixture to form the blend.

33. The process of claim 32, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber, neoprene, polychloroprene, butyl rubber, nitrile rubber and blends thereof.

34. The process of claim 33, wherein the general purpose rubber is selected from the group consisting of natural rubber, polybutadiene, polyisoprene, styrene-butadiene rubber, styrene-isoprene rubber, styrene-isoprene-butadiene rubber, isoprene-butadiene rubber and blends thereof.

35. The process of claim 34, wherein the general purpose rubber is selected from the group consisting of natural rubber, polybutadiene, styrene-butadiene rubber and blends thereof.

36. The process of claim 32, wherein the C₄ to C₇ isoolefin is isobutylene.

37. The process of claim 36, wherein the para-alkylstyrene is para-methylstyrene.

38. The process of claim 32, wherein the copolymer is a terpolymer of isobutylene, para-methylstyrene and bromo para-methylstyrene.

39. The process of claim 32, wherein the blend is colorable.

40. The process of claim 32, wherein the blend is substantially free of carbon black and antioxidant.

41. A blend comprising:
an isoolefin/para-alkylstyrene copolymer, the isoolefin having between 4 and 7 carbon atoms and the copolymer containing from about 0.5 wt % to about 20 wt % by weight para-alkylstyrene, and wherein from about 0.2 mole % to about 3 mole % of the methyl groups present on the benzene ring of the para-alkylstyrene contain a halogen atom;
a general purpose rubber selected from the group consisting of polybutadiene, polyisoprene, styrene-butadiene rubber, styrene-isoprene rubber, styrene-isoprene-butadiene rubber, isoprene-butadiene rubber, neoprene, polychloroprene, butyl rubber and nitrile rubber as well as mixtures thereof;
a silica filler; and
at least one silane coupling agent of the following structure: 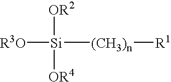
wherein R¹ can be a vinyl, sulfur, amine, alkylthiol, alkylamine, alkylsilane, alkoxysilane, methacrylate, nitroso, or halogen group; R² through R⁴ can be the same or different, and can be an alkyl, aryl alkyl group, or a phenyl group, and n is an integer from 1 to 10.

42. The blend of claim 41, wherein the C₄ to C₇ isoolefin is isobutylene.

43. The blend of claim 42, wherein the silane coupling agent is selected from the group consisting of bis(3-triethoxysilylpropyl) tetrasulfide, 3-thiocyanatopropyl-triethoxy silane, 3-mercaptopropyl-trimethoxy silane, vinyl triethoxysilane, vinyl-tris-(beta-methoxyethoxy)silane, methacryloylpropyltrimethoxysilane, gamma-amino-propyl triethoxysilane, gamma-mercaptopropyltrimethoxysilane bis(2-triethoxysilyl-ethyl) tetrasulfide, bis(3-trimethoxysilyl-propyl) tetrasulfide, bis(2-trimethoxysilyl-ethyl) tetrasulfide, 3-mercaptopropyl-triethoxy silane, 2-mercaptopropyl-trimethoxy silane, 2-mercaptopropyl-triethoxy silane, 3-nitropropyl-trimethoxysilane, 3-nitropropyl-triethoxysilane, 3-chloropropyl-trimethoxysilane, 3-chloropropyl-triethoxysilane, 2-chloropropyl-trimethoxysilane, 2-chloropropyl-triethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropyl-benzothiazole tetrasulfide, 3-trimethoxysilylpropyl-methacrylate monosulfide, 3-trimethoxysilylpropyl-methacrylate monosulfide, and mixtures thereof.
